(19) United States
(12) Patent Application Publication
(10) Pub. No.: US 2006/0292034 A1
(43) Pub. Date: Dec. 28, 2006

(54) Saliva sample testing device

(75) Inventors: Martin Gould, Mullica Hill, NJ (US); Yli Remo Vallejo, Newark, DE (US); Robert Bernstine, Chesapeake City, MD (US)

Correspondence Address: Edmund M. Jaskiewicz, Suite 400, 1730 M Street NW, Washington, DC, 20036, US

(73) Assignee: American Bio Medica Corporation

(21) Appl. No.: 11/167,227

(22) Filed: Jun. 28, 2005

(51) Int. Cl. G01N 31/22

(52) U.S. Cl. 422/58; 422/61

(57) ABSTRACT

In this testing device, a saliva sample and a buffer solution are delivered from separate chambers into a mixing chamber to mix with a second reagent. The resulting test mixture is allowed to incubate for a pre-determined period of time and then selectively delivered to a test strip

### BACKGROUND OF THE INVENTION

1. Field of the Invention

The present invention relates to testing of saliva samples for drugs of abuse, more particularly, to a device and process which permits the saliva sample to be treated and incubated for a predetermined period of time prior to being introduced to an immunoassay test strip.

2. Description of Related Art

The increased availability and use of drugs of abuse by the general population has caused employers, governmental agencies, sports groups and other organizations to utilize drug screening both as a condition of employment and in order to maintain safety in the work place. Screening tests for the detection of drugs of abuse range in complexity from simple immunoassay tests to very complex analytical procedures. Over the years the speed and specificity of immunoassays have made them one of the most accepted methods for screening for drugs of abuse in body fluids. Typical drug screening tests are performed for the purpose of quickly identifying on a qualitative basis the presence of drugs in a body fluid which may be urine or saliva. A complete analysis of the sample may then be carried out in a laboratory only if the preliminary screening results are positive. More and more such drug screenings are taking place on site or at the work place and are generally carried out by testing personnel who are generally not technically trained, such as laboratory technicians. It is thus important that the drug screening procedure is simple but yet reliable. Further, the test apparatus must be such so as to enable the testing personnel to avoid all contact with the fluid specimen which is being tested.

While blood and urine samples have long been the primary fluids used for testing for disease as well as for evidence of substance abuse, there is increasing interest in testing of saliva specimens. Some advantages in testing saliva are that it is relatively easy to obtain a saliva sample and that a saliva sample cannot be adulterated. Also, testing of saliva gives a result in real time within a span of several hours as compared to urine which gives a test result after-the-fact.

However, the collection and analysis of saliva for diagnostic purposes is complicated by the relatively high viscosity of the fluid. Thus, once a saliva test sample is introduced into a test device, there is little user control over the subsequent events since the fluid flow determines the speed and timing of all of the reactions. Also, if the sample requires pre-treatment with specific reagents to dilute or denature interferants, modify analyte structure, or release analyte from binders, such treatments are generally performed outside the confines of the test device. It has become apparent that numerous advantages would be derived from a self-contained saliva sample test device that allows control over the test sample and is simple to use so that more accurate test results may be obtained.

U.S. Pat. No. 6,634,243—Wickstead is such a prior art device which has an inadequate and ineffective provision for control of the test sample. Other relevant prior art includes U.S. Pat. No. 6,267,722—Anderson et al, U.S. Pat. No. 6,214,629—Freitag et al and U.S. Pat. No. 5,630,986—Charlton et al.

### SUMMARY OF THE INVENTION

It is, therefore, the principal object of the present invention to provide a novel and improved saliva test device and a method of carrying out a saliva test.

It is another object of the present invention to provide such a saliva test device that allows the test sample to be treated and incubated prior to being introduced to the test strip.

It is a further object of the present invention to provide a saliva test device which is simple and easy to operate.

It is an additional object of the present invention to provide such a saliva test device that has selective control over the flow of the test sample to the test strip to increase the sensitivity of the assay.

The objects of the present invention are achieved and the disadvantages of the prior art are eliminated by the saliva test device according to the present invention which has a housing having an immunoassay test strip supported therein and a mixing chamber. The housing further has a means for delivering a first reagent to the mixing chamber and a means for delivering a test sample to the mixing chamber in which is formed a first mixture of first reagent and test sample. The housing additionally has a means for delivering a second reagent to the first mixture in the mixing chamber to form a test mixture. There is also a means within the the housing for delivering the test mixture to the test strip after a predetermined period of time has elapsed after the forming of the test mixture.

On one embodiment of the invention this housing may comprise a pair of cylindrical chambers extending vertically and parallel to each other. Each of the chambers has a bottom opening communicating to the mixing chamber. The test strip may be mounted between the cylindrical chamber such that its sample receiving end is adjacent to the mixing chamber. A valve member is interposed between the mixing chamber and the test strip and is movable between open and closed positions. The valve member may comprise a slidable plate having an opening therein and a trigger or operating handle extending to the exterior of the housing for selective operation. The chamber for delivering the first reagent has an upwardly directed piercing member fixed therein which engages a rupturable bottom of a reagent cup container inserted within the chamber. The test sample, preferably on a swab end of a collector, is received within the second chamber when the swab is pushed against an abutment structure such that the sample is expressed from the swab and descends by gravity through a bottom opening to the mixing chamber below.

In a modification of the invention the test strip may be mounted to the side of the second chamber. Further, the slidable plate valve member may be slidable either horizontally or vertically within the housing to open the mixing chamber to the test strip.

The process according to the present invention may comprise providing a testing device having a housing in which is formed a mixing chamber and which supports an immunoassay test strip such that the “results” portion of the test strip is visible from the exterior of the housing. A buffer solution and a test sample are delivered to the mixing chamber to form a first mixture. A binder is delivered to the first mixture to form a test mixture. The test mixture is allowed to incubate for a predetermined period of time and is then delivered to the test strip. The test results are observed on the “results” portion of the test strip.

### BRIEF DESCRIPTION OF THE DRAWINGS

Other objects and advantages of the present invention will be apparent upon reference to the accompanying descriptions when taken in conjunction with the following drawings, which are exemplary, wherein:

FIG. 1 is a perspective view of the test device according to the present invention and also showing a sample collector in position to be inserted into the device;

FIG. 2 is a perspective view similar to that of FIG. 1 but showing the housing cover removed;

FIG. 3 is a perspective view similar to that of FIGS. 1 and 2 but with the front column removed to show the interiors of the reagent and test cylinders;

FIG. 4 is a sectional view taken along the line IV-IV in FIG. 3 to show in cross-section the buffer cup and buffer button;

FIG. 5 is a sectional view taken along the line V-V on FIG. 1;

FIG. 6 is a perspective view of the base of the device with the cylinders removed and showing the trigger in the closed position;

FIG. 7 is a perspective view similar to that of FIG. 6 and showing the mixing chamber and the trigger in the open position;

FIG. 8 is a perspective view of the sample collector having a cap to protect the swab;

FIG. 9 is a vertical longitudinal sectional view of the sample collector as shown in FIG. 8.

FIG. 10 is a perspective view of the trigger per se which is assembled in the base of the device as seen in FIGS. 6 and 7.

FIG. 11 is a perspective view similar to that of FIG. 1 of a modification of the testing device;

FIG. 12 is a vertical sectional view of the testing device shown in FIG. 11;

FIG. 13 is a perspective vview of another modification of the testing device according to the present inventions;

FIG. 14 is a vertical sectional view of the testing device shown in FIG. 13.

FIG. 15 is a vertical sectional view similar to that of FIG. 13 but showing the trigger depressed to dispense the mixture to the test strip.

### DETAILED DESCRIPTION OF THE INVENTION

Proceeding next to the drawings wherein like reference symbols indicate the same parts throughout the various views, a specific embodiment and modifications of the present invention will be described in detail.

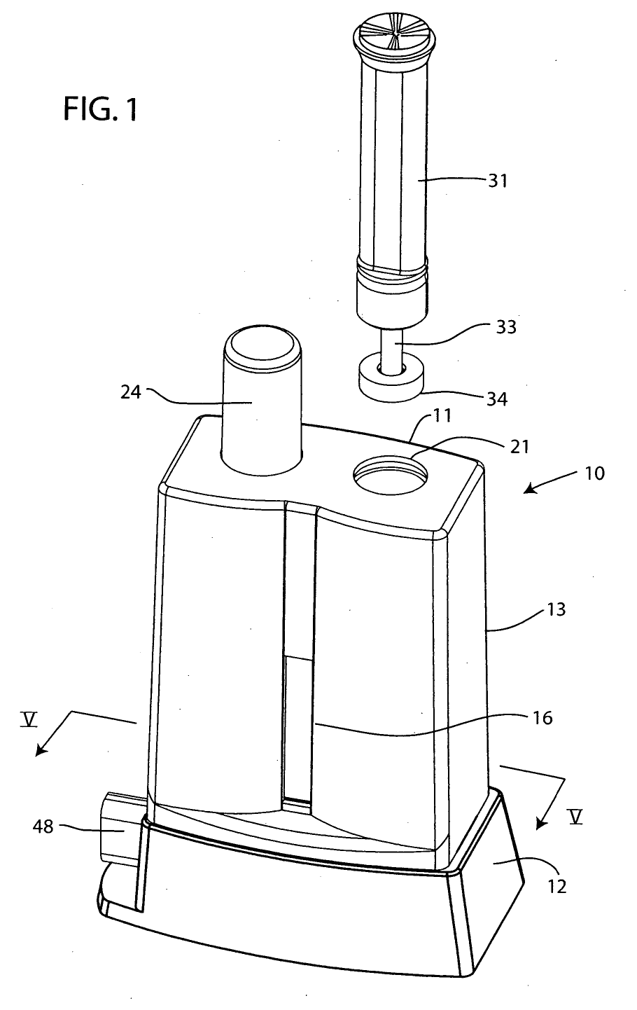

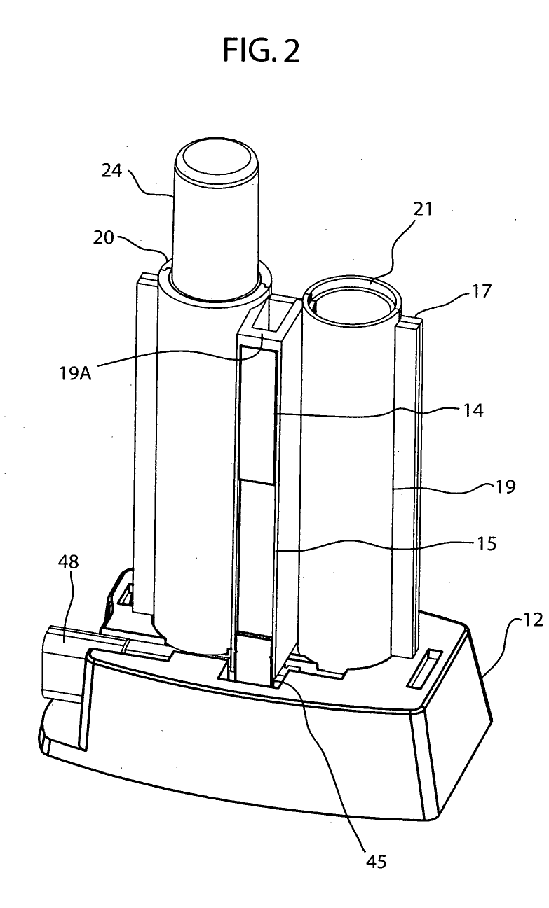

As may be seen in FIG. 1, a saliva sample testing device according to the present invention is indicated generally at 10 and comprises a body member 11 having a base 12 upon which is mounted a housing 13 within which is supported in a vertical position an immunoassay test strip 14 having a “results” portion 15 which is visible to the exterior through a viewing widow 16 in the housing. The housing 13 also encloses an upper body portion 17 which comprises a rear column structure 18 on to which a front column structure 19 is attached to define a pair of vertical parallel cylinders 20 and 21. The front column 19 has a vertical hollow central portion 19A between the vertical cylinders 20 and 21. Test strip 14 is mounted on the front side of the hollow central portion 19A as seen in FIG. 2

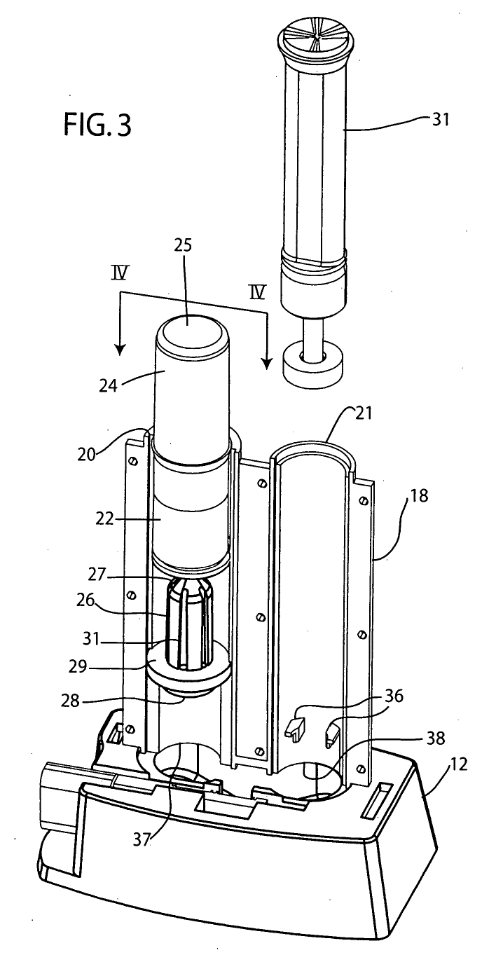

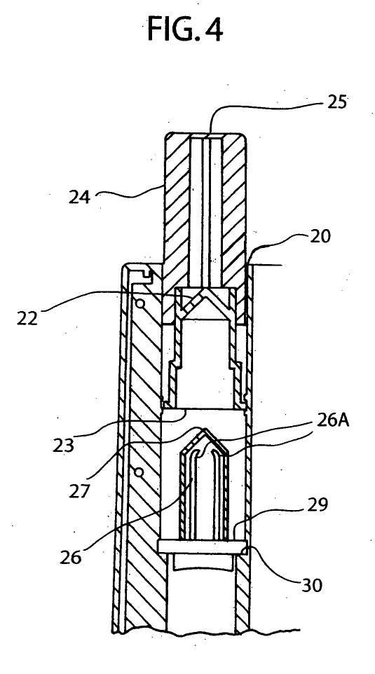

Cylinder 20 delivers a reagent which may be a buffer solution enclosed in a buffer cup 22 and shown in greater detail in FIG. 4. The buffer cup has a bottom 23 formed of a rupturable or pierceable material. A buffer button 24 is positioned on top of the buffer cup such that when a downward force is applied to the top 25 of the buffer bottom, the buffer cup will be forced downwardly and the bottom 23 is ruptured by a piercing member or spike 26 to release the buffer solution within the cup. The piercing member 26, shown in greater detail in FIG. 3, comprises a hollow tubular member having a closed and pointed top end 27 and an open bottom end, 28 fixed in an annular member 29 seated and preferably fixed on an annular shoulder 30 on the interior surface of cylinder 20. The piercing member 26 has a pluralty of longitudinally extending slots 26A therein to provide paths for buffer solution released from the buffer cup.

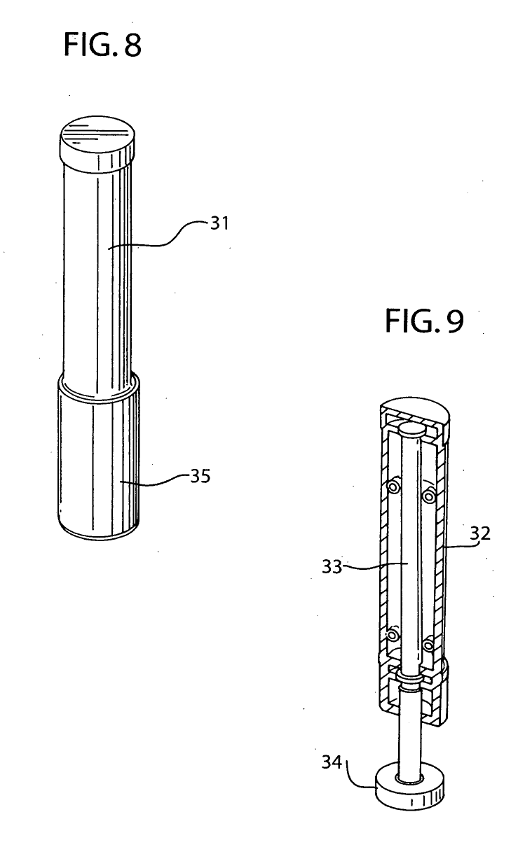

The second cylinder 21 receives the sample to be tested and accommodates a sample collecter 31 shown in greater detail in FIGS. 8 and 9. The collector comprises a hollow tubular housing 32 within which is supported a rod 33 the lower end of which extends from the housing and supports thereon an absorbent swab 34 which may be PVA. The swab 34 is enclosed by a removable protective cap 35 which is removed to enable a saliva sample to be collected on the swab 34 and then removed just prior to inserting the collector into the saliva testing device as seen in FIG. 1. Upon absorbing a saliva sample the swab will expand along the rod 33 and may even reach the bottom of the housing 32.

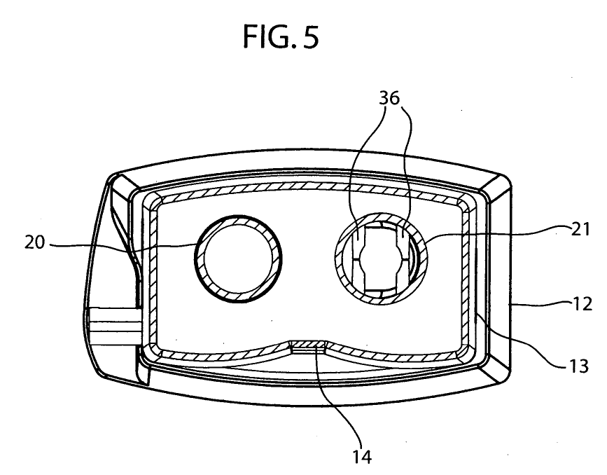

When the collector is inserted into cylinder 21, it is pushed into the cylinder until the swab 34 engages a pair of spaced parallel abutments 36 as may be seen in FIGS. 3 and 5. Continued pressure on the collector will compress the swab 34 against the abutments while the bottom end of the rod passes between the abutments. The saliva sample is thus expressed from the swab and descends downwardly in the cylinder.

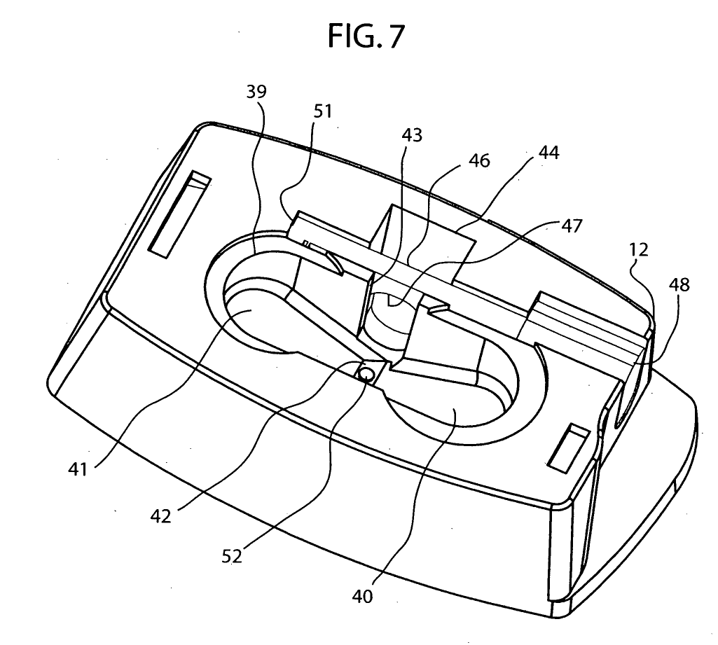

Cylinders 20 and 21 have bottom openings 37 and 38, respectively, both of which open into a chamber 39 formed within the base 12 and shown in greater detail in FIGS. 7 and 7. The bottom of the chamber 39 is formed by a pair of inclined surfaces 40 and 41 which slope downwardly toward each other to define a mixing chamber 42 at substantially the meeting of the lower edges of the surfaces 40 and 41.

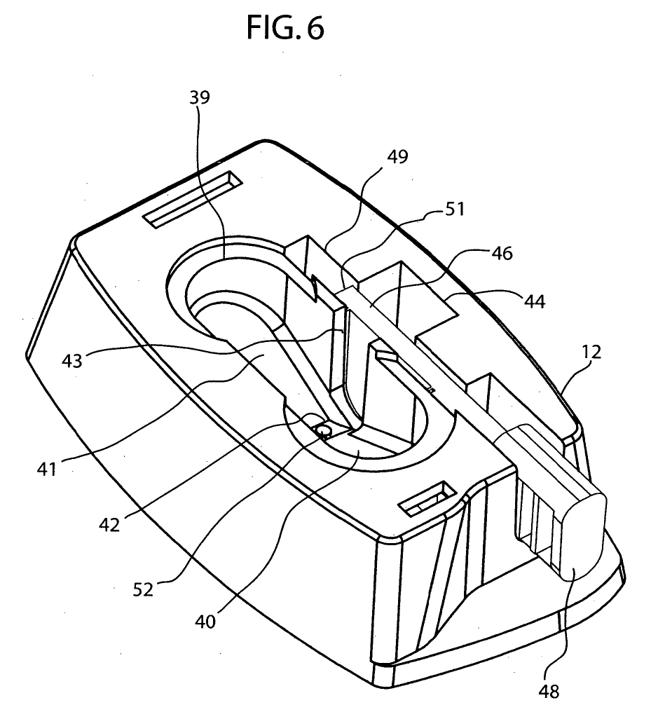

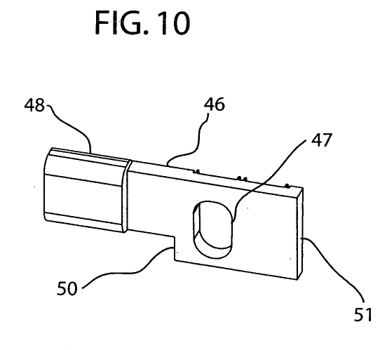

An opening 43 in a side of the base chamber 39 at the location of the mixing chamber 42 communicates with a space or chamber 44 in which is positioned the sample receiving end 45 of the test strip 14. Interposed between the mixing chamber 42 and test strip chamber 44 is a slide valve 46 or trigger shown in greater detail in FIG. 10. The slide valve has an opening 47 therethrough, which when in the position as shown in FIG. 7 provides communication between the mixing chamber 42 and test strip chamber 44. At the end of the valve extending outwardly of the base there is an actuating handle or trigger 48. The valve 46 slides longitudinally within an elongated space 49 configured to limit the movement of the valve in either direction Movement of the valve 46 to its closed position as seen in FIG. 6 is limited by an abutment 50 on the valve contacting a shoulder within the valve space 49 and movement to its open position is limited by valve end 51 contacting the end of Valve space 49 as seen in FIG. 7.

A second reagent 52, which may be a binder such as a colloidal gold-antibody complex or an antigen may be stored or positioned during assembly of the testing device in the mixing chamber 42 as shown in FIGS. 6 and 7.

In order to use the device to conduct a test after a saliva sample has been collected on swab 34 of the sample collector 31, the buffer cup button 24 is depressed which urges the bottom 23 of the buffer cup 22 against the piercing member 26 to rupture the bottom 23 and release the buffer solution downwardly onto the bottom sloping surface 40. The buffer solution then flows into the mixing chamber 42 and reacts with the second reagent 52. The collector cap 35 is removed and the collector swab 34 is inserted into chamber 21 and pushed downardly to express the saliva sample from the swab as described above. The test sample drops onto the bottom sloping surface 41 to flow downwardly into the mixing chamber 42 to mix with the buffer solution and react with the second reagent 52. Mixing will occur in a matter of 2-3 seconds and the resulting test mixture is allowed to react for a pre-determined period of time. That is, the test mixture is incubated for 2-3 minutes.

After completion of the incubation period, the trigger 48 is pushed inwardly to its open position to provide communication between mixing chamber 42 and test strip chamber 44 to deliver the test mixture to the test strip. Any reactions on the test strip 14 may be observed through the viewing window 16 in the housing.

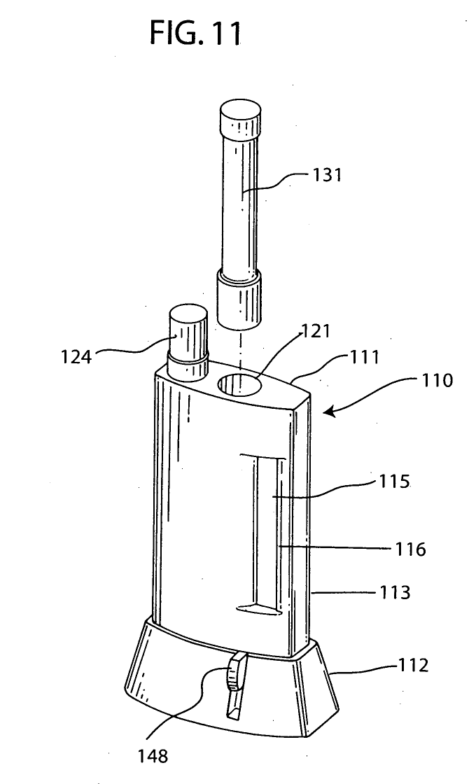

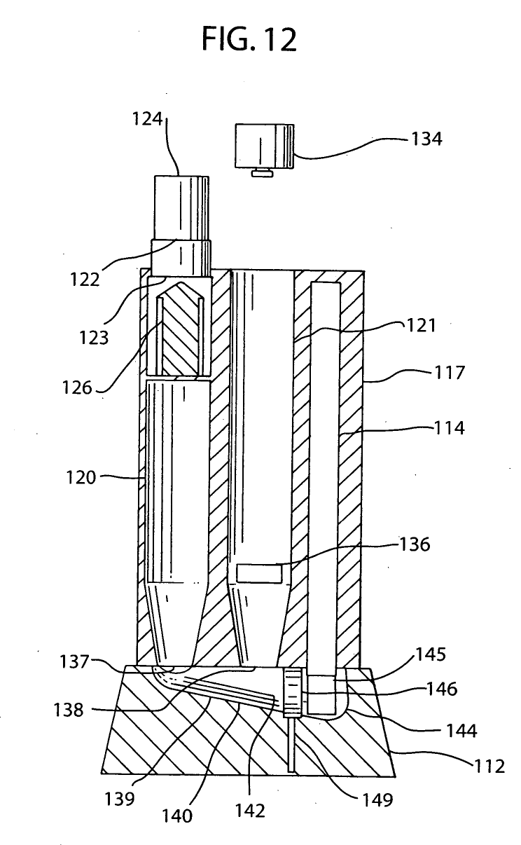

In FIGS. 11 and 12 there is shown at 110 a saliva testing device which is a modification of the testing device 10 described above. Testing device 110 similarly comprises a body member 111 having a base 112 upon which is mounted a housing 113 enclosing an upper body portion 117 which has a receiving window 116 therein. A pair of vertical parallel cylinders 120 and 121 are positioned adjacent each other in the upper body portion 117. A test strip 114 is mounted on upper body portion 117 positioned adjacent cylinder 121 and has a results portion 115 visible through window 116. A sample receiving end 145 of the test strip 114 extends into a chamber 144 which communicates with a mixing chamber 142 in the base 112. The cylinders 120 and 121 have bottom openings 137 and 138 opening into a chamber 139 within the base 112 and having an inclined bottom surface 140 which slopes downwardly to the mixing chamber 142. Interposed between the mixing chamber 142 and test strip chamber 144 is a plate slide valve or trigger 146 having an end extending outwardly of the base which has an actuating handle or trigger 148 thereon. In its upper positions as shown in FIGS. 11 and 12, the plate valve 146 closes communication between mixing chamber 142 and test strip chamber 144. The valve plate is slidable vertically and transversely of itself within a valve space 149. The trigger 148 is depressed downwardly to open communication between mixing chamber 142 and test strip chamber 144.

The housing 113 encloses the upper body portion 117 but has the opening 116 which permits viewing of the “results” portion 115 of the test strip 114. The cylinder 120 has on its upper end a buffer button 123 which moves buffer cup 122 downwardly against a piercing member 126. Cylinder 121 receives a sample collector 131 having a sample swab 134 which is pushed against abutments 136 to express a saliva sample downwardly onto the sloping surface 140.

A second reagent may be positioned during assembly of the testing device in the mixing chamber 142.

To operate testing device 110 after a saliva sample has been collected on collector swab 134 of the collector 131, the buffer button 124 is depressed to cause the buffer cup bottom 123 to be pierced by piercing member 126 to release the buffer solution downwardly onto the sloping surface 140. The collector swab 134 is inserted into sylinder 121 and pushed downwardly to urge the swab 134 against abutments 136 to express the saliva sample downwardly onto the sloping surface 140 to mix with the buffer solution and the resulting mixture mixes with the second reagent in the mixing chamber 142 at the lower end of the sloping surface 140 to form a test mixture. After an incubation period of 2-3 minutes, the trigger 148 is depressed to move the plate slide valve 146 downwardly to open communication between the mixing chamber and test chamber. In the test chamber the test mixture contacts the sample receiving end 145 of the test strip 114. Any reaction on the test strip may be observed through the viewing window 116.

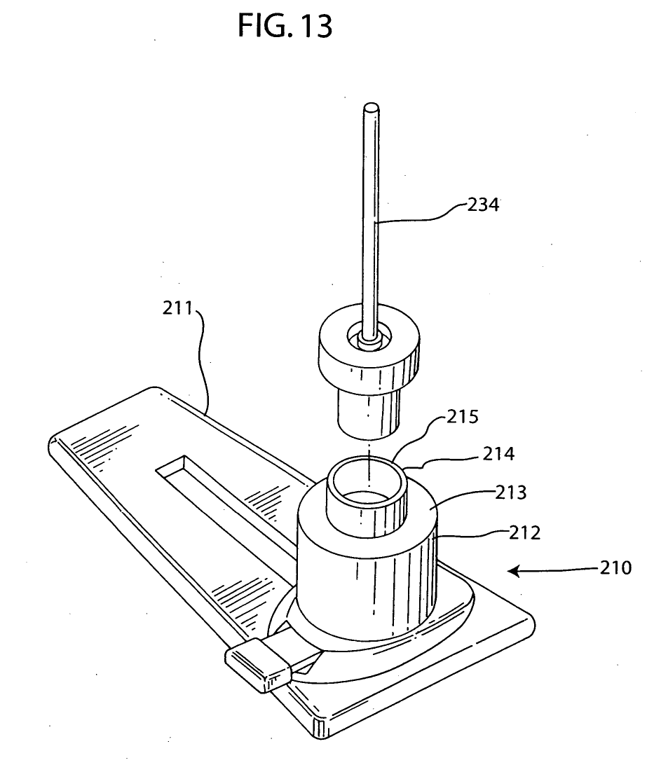

In FIGS. 13-15 there is shown at 210 another modification of the testing device of the present invention. Testing device 210 has a flat hollow base 211 upon which is mounted a cylinder 212 having a top 213 upon which is a second but smaller diameter cylinder 214 which has an open top end 215. The cylinders 212 and 214 are aligned vertically and are coaxial with each other The cylinder 212 has a bottom end 216 which opens into a raised position 217 on base 211 which opens to the interior of the base 211 and cylinder 214 has a bottom end 218 which opens into cylinder 212.

Positioned within the cylinder 212 is an annular shaped buffer cup 219 having an inverted V cross-section, as shown in FIG. 16, and having a bottom 220 closed by a rupturable material. A cross-piece 221 extends diametrically across the buffer cup 219. Mounted below the buffer cup 219 is an annular spike or piercing member 222 having a cross-section conforming to the cross-section of the buffer cup 219 and a sharpened top edge 223 engageable with the bottom 220 of buffer cup 219. Below the spike 222 is a frusto-conical shaped mixing chamber 224 tapering inwardly in a downward direction and closed off by a plate slide valve 225 having a trigger 226. The valve 225 is slidable longitudinally within a valve chamber 227 formed within the base raised portion 217. Below the mixing chamber 224 is a test chamber 228 within which is positioned the sample receiving end 229 of a test strip 230. Test strip 230 has a results portion 231 which is visible through a viewing window 232 formed in the top wall of the base 211.

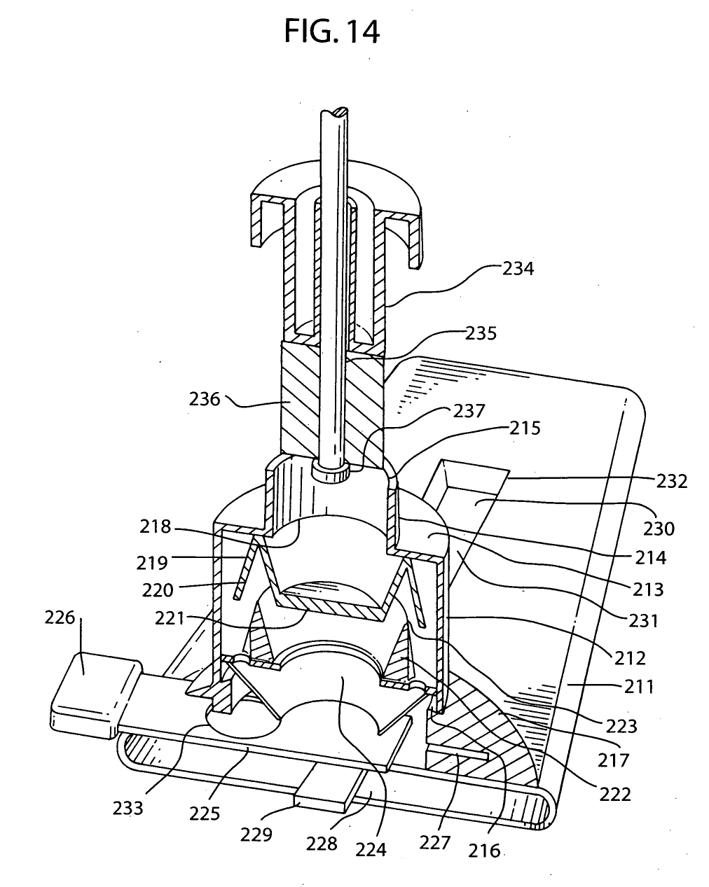

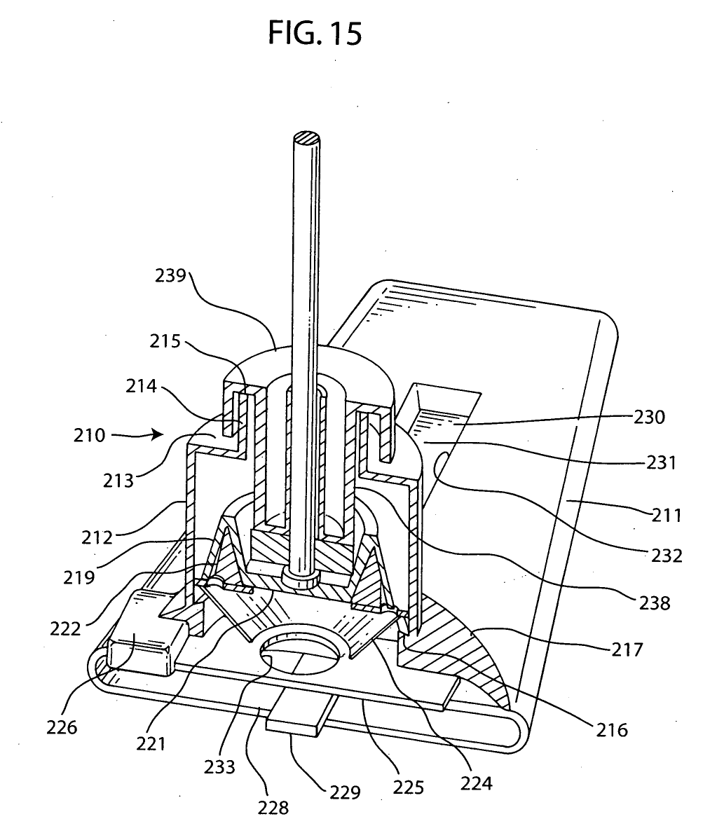

The slide valve 225, as shown in FIG. 14, in its closed position, has an opening 233 therein which opens the bottom of the mixing chamber 224 to the test chamber 228 as shown in FIG. 15 when the trigger 226 is depressed or pushed inwardly of the testing device.

The top end 215 of cylinder 214 receives a sample collector 234 which has a central rod 235 on the lower end of which is mounted a sample collector swab 236. The rod 235 has a flattened and enlarged end 237 which is engageable with the crosspiece 221 in buffer cup 219 and also retains the swab 236 on the rod. Also mounted on the rod 235 and above the swab 236 is a cylindrical plunger 238 which bears against the upper surface of swab 236 and has an annular flange 239 which engages the top edge of open end 215 of cylinder 214.

A second suitable reagent is positioned in the mixing chamber during assembly of the testing device.

In operation of the testing device 210 after a saliva sample has been colledted on the swab 236, the collector is introduced into into the top end 215 of cylinder 214 as shown in FIG. 14. The collector central rod 235 is pushed downwardly to engage the rod end 237 with buffer cup crosspiece 221. Continued downwardly pushing of rod 235 will cause the bottom of buffer cup 219 to be ruptured by spike top edge 223 to release buffer solution into the mixing chamber 224. The annular flange 239 is pushed downwardly to squeeze the swab and to express saliva sample therefrom into the mixing chamber to mix with the buffer solution and with a second reagent in the mixing chamber to form a test mixture. After an incubation period of 2-3 minutes, the trigger 226 is pushed inwardly to deliver the test mixture through valve opening 233 into the test chamber 228 and sample receiving end 229 of the test strip. Any reactions on the test strip may be viewed through window 232.

Thus, it can be seen that the present invention discloses a novel and improved saliva testing device which is also simple and effective in operation. This improved device gives the user the option to initiate the operative steps as may be desired to conduct a test. After a test sample of saliva has been collected, the person conducting the test depresses the buffer button to initiate the delivery of the buffer solution to the mixing chamber into which a second reagent has been placed. The test operator then delivers the test sample to the mixing chamber to mix with the buffer solution and the second reagent. The user then initiates the delivery, at his option, of the test mixture to the test strip. The flow or delivery of the test mixture to the test strip after an incubation period is controlled by the user. The flow or passage of the test sample within the testing device is under the control of the user who can selectively initiate each of: the delivery of the buffer solution, the delivery of the test sample, and the delivery of the test sample mixture to the test strip.

It will be understood that this invention is susceptible to modification in order to adapt it to different usages and conditions, and accordingly, it is desired to comprehend such modifications within this invention as may fall within the scope of the appended claims.

What is claimed is:

1. A saliva sample testing device comprising
a body member having an immunoassay test strip supported therein and means for defining a mixing chamber,
means in said body member for delivering a first reagent to said mixing chamber,
means in said body member for delivering a test sample to said mixing chamber such that a first mixture of said first reagent and said test sample is formed in said mixing chamber
means in said body member, for introducing a second reagent to said first mixture in said mixing chamber to form a test mixture,
and means for delivering said test mixture to said test strip after a predetermined period of time has elapsed after the forming of the test mixture.

2. A saliva sample testing device as claimed in claim 1 wherein
said means for delivering said test mixture comprises means for providing communication between said mixing and test chambers to enable the test mixture to be delivered to said test strip.

3. A saliva sample testing device as claimed in claim 1 wherein
said means for delivering said first reagent comprises a first chamber having a bottom end opening to said mixing chamber,
said means for delivering a test sample comprises a second chamber having a bottom end opening to said mixing chamber.

4. A saliva sample testing device as claimed in claim 3 wherein
said first and second chambers each being cylindrical and extending vertically in said body member parallel to each other.

5. A saliva sample testing device as claimed in claim 4 wherein
said test strip extends vertically and parallel to said first and second chambers.

6. A saliva sample testing device as claimed in claim 1 wherein
said means for delivering said test mixture being interposed between said mixing chamber and said test strip.

7. A saliva sample testing device as claimed in claim 6 wherein
said means for delivering said test mixture comprises a valve member movable between opened and closed positions.

8. A saliva sample testing device as claimed in claim 7 wherein
said valve member comprises a slidable elongated plate having an opening therein.

9. A saliva sample testing device as claimed in claim 8 wherein
said plate is horizontally slidable along its longitudinal axis.

10. A saliva sample testing device as claimed in claim 3 wherein
said means for delivering a first reagent further comprises a cup container having a rupturable end surface,
said container being inserted into said first chamber rupturable end first.
and a piercing member fixed in said first chamber and engageable with said rupturable end surface.

11. A saliva sample testing device as claimed in claim 10 wherein
said piercing member comprises a tubular element having a pointed closed top end and an open bottom end,
said tubular element having at least one longitudinally extending slot therein.

12. A saliva sample testing device as claimed in claim 10 wherein said first chamber has a top end opening on the top surface of said body member,
and an actuating button slidably mounted in said top opening and engageable with said cup conatiner when depressed

13. A saliva sample testing device as claimed in claim 11 and further comprising
an annular member around said open end of said tubular element and having a rim mounted on the inner surface of said first chamber.

14. A saliva sample testing device as claimed in claim 5 wherein
said test strip is supported between said first and second chambers.

15. A saliva sample testing device as claimed in claim 5 wherein
said test strip is supported adjacent to said second chamber.

16. A saliva sample testing device as claimed in claim 8 wherein
said elongated plate is movable transversely in a vertical direction.

17. A saliva sample testing device as claimed in claim 3 wherein
said first and second chambers are cylindrical and coaxial with each other.

18. A saliva sample testing device as claimed in claim 3 wherein
said first chamber comprises an annular cup having said first reagent therein and being coaxial to said second sample chamber
said mixing chamber having an annular piercing member engageable with said annular cup to release said first reagent

19. A saliva sample testing device as claimed in claim 18 wherein
said first reagent chamber, said second sample chamber and said mixing chamber are aligned vertically.

20. A saliva sample testing device as claimed in claim 19 wherein
said test strip is supported horizontally in said body member substantially at a right angle to said vertically aligned chambers and having a sample receiving end in said mixing chamber

21. A saliva sample testing device as claimed in claim 1 wherein
said means for delivering a test sample comprises a second chamber having a cylindrical shape and disposed vertically in said body member,
and a sample collector comprising a rod having a swab on one end thereof and shaped to be received within said second chamber.

22. A saliva sample testing device as chimed in claim and further comprising
means within said second chamber for defining an abutment across a portion of the interior of said second chamber against which said collector swab can be pushed to express sample from said swab into said mixing chamber.

23. A saliva sample testing device as claimed in claim 22 wherein
said abutment means comprises a plurality of spaced bars between which expressed sample will flow to said mixing chamber.

24. A saliva sample testing device as claimed in claim 1 wherein
said body member comprises a base and a housing mounted on said base, said test strip is supported in said housing and said mixing chamber is within said base.

25. A process for testing a saliva sample comprising the steps of
providing a testing device comprising a housing with a mixing chamber and an immunoassay test strip supported in said housing such that a results portion of the test strip is visible from the exterior of the housing,
delivering a buffer solution to the mixing chamber,
delivering a test sample to the mixing chamber to mix with the buffer solution to form a first mixture,
delivering a binder to the mixing chamber to mix with the first mixture to form a test mixture,
delivering the test mixture to the test strip after a pre-determined period of time has elapsed to allow incubation of the test mixture,

26. A process for testing a saliva sample comprising the steps of
providing a testing device comprising a housing having first and second chambers each of which has a bottom opening communicating with a mixing chamber and an immunoassay test strip supported in the housing adjacent the mixing chamber such that a test results portion of the test strip is visible from the exterior of the housing,
delivering a first reagent from said first chamber to the mixing chamber,
collecting a test sample in said second chamber and delivering the test sample to the mixing chamber to mix with the first reagent to form a first mixture,
introducing a second reagent to the mixing chamber to mix with said first mixture to form a test mixture,
allowing the test mixture to incubate in the mixing chamber for a predetermined period of time,
delivering the incubated test mixture to the test strip,
and determining the test results by observing the test strip.

27. A process for testing a saliva sample as claimed in claim 26 wherein
said first reagent includes a buffer solution.

28. A process for testing a saliva sample as claimed in claim 26 wherein
said second reagent is a binder.

29. A process for testing a saliva sample as claimed in claim 28 wherein
said binder is a colloidal gold-antibody complex.

30. A process for testing a saliva sample as claimed in claim 26 wherein
said second reagent is an antigen.
